(19) United States
(12) Patent Application Publication
(10) Pub. No.: US 2016/0109903 A1
(43) Pub. Date: Apr. 21, 2016

(54) ELECTRONIC DEVICE WITH DISPLAY PANEL

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: DA-LONG SUN, Wuhan (CN); JUN-ZHI XU, Wuhan (CN)

(21) Appl. No.: 14/526,258

(22) Filed: Oct. 28, 2014

(30) Foreign Application Priority Data
Oct. 15, 2014 (CN) 201410543850.6

(51) Int. Cl. G06F 1/16

(52) U.S. Cl. CPC G06F 1/1601

(57) ABSTRACT

An electronic device includes a mounting frame, a plurality of latching members, a rear cover, a display panel, and a plurality of fasteners. The mounting frame includes a plurality of installation portions. The plurality of latching members is secured to the installation portions. The display panel is located between the latching members and the rear cover. The plurality of fasteners are is engaged with the installation portions through the rear cover to secure the rear cover and the display panel to the mounting frame.

### FIELD

The subject matter herein generally relates to an electronic device with display panel.

### BACKGROUND

An electronic device, such as a notebook, generally includes a rear cover, a mounting frame secured to the rear cover, and a display panel adhered to the rear cover and secured to the mounting frame by screws threaded into holes defined in the mounting frame and the display panel.

### BRIEF DESCRIPTION OF THE DRAWINGS

Implementations of the present technology will now be described, by way of example only, with reference to the attached figures.

FIG. 1 is an exploded, isometric view of an embodiment of an electronic device.

FIG. 2 is an enlarged view of the circled portion II of the electronic device of FIG. 1.

FIG. 3 is an assembled, isometric view of the electronic device of FIG. 1.

FIG. 4 is an enlarged view of the circled portion IV of the electronic device of FIG. 3.

FIG. 5 is a cross sectional view of the electronic device of FIG. 3, taken along a line V-V.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

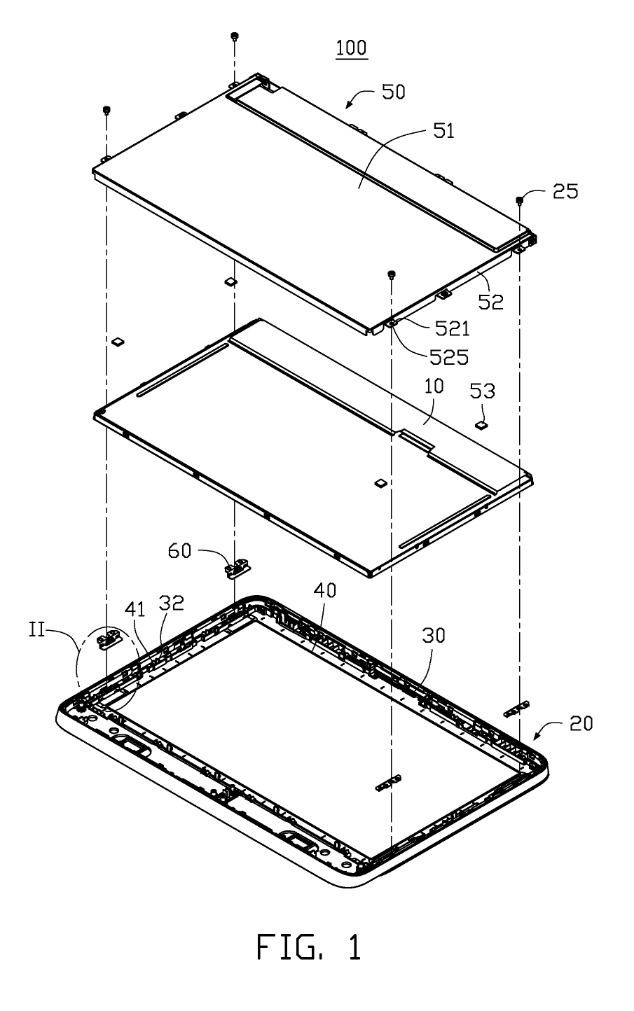

FIG. 1 illustrates an electronic device in accordance with an embodiment. The electronic device 100 includes a display panel 10, a mounting frame 20, a rear cover 50, and a plurality of latching members 60.

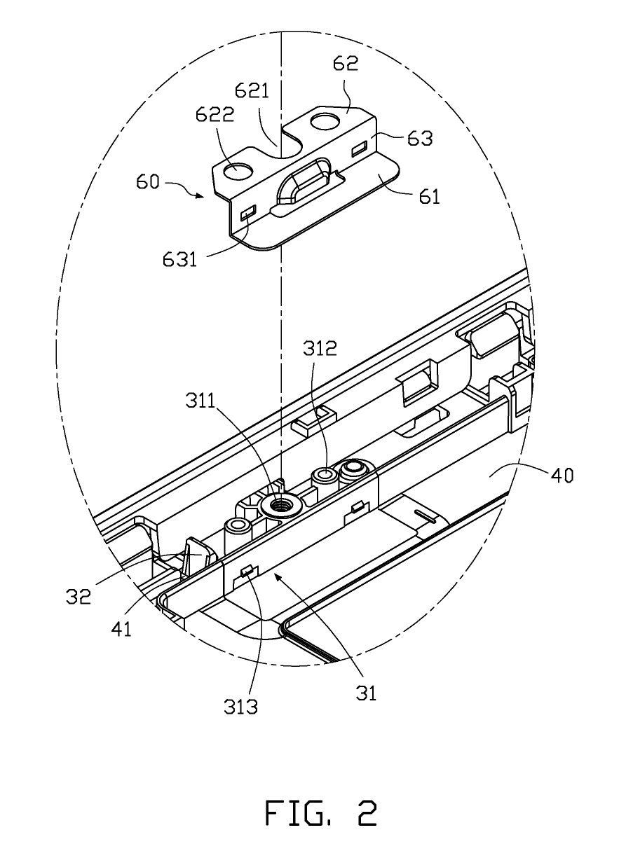

FIG. 1 and FIG. 2 illustrate that the mounting frame 20 includes an outer frame 30 and a holding frame 40. An installation portion 31 is located near each of four corners of the outer frame 30. The installation portion 31 defines a mounting hole 311 and includes two positioning posts 312 located on opposite sides of the mounting hole 311, and two blocks 313. A fastener 25 can be threaded into the mounting hole 311. The positioning posts 312 and the blocks 313 can be used for latching the latching member 60. A plurality of latching portions 32 is located on the outer frame 30 for securing the holding frame 40. The holding frame 40 includes a plurality of latching ribs 41. The latching ribs 41 are elastically deformable to engage with the latching portion 32 to secure the holding frame 40 to the outer frame 30. The holding frame 40 can be used for holding the display panel 10.

The rear cover 50 includes a covering plate 51, four side plates 52 substantially perpendicularly coupled to edges of the covering plate 51, and a plurality of resilient members 53. The covering plate 51 and the side plates 52 can fully cover the display panel 10. Each resilient member 53 is located between the covering plate 51 and the display panel 10. Two mounting pieces 521 extend from each of opposite two of the side plates 52. Each mounting piece 521 defines a through hole 525. The fastener 25 can be inserted through the through hole 525 and the mounting hole 311 to secure the mounting frame 20 to the rear cover 50. The resilient members 53 are elastically deformable at different height according to a thickness of the display panel 10.

The latching member 60 includes a first flange 61, a second flange 62, and a coupling piece 63. The first flange 61 and the second flange 62 extend from opposite edges of the coupling piece 63 in opposite directions. In at least one embodiment, each of the first flange 61 and the second flange 62 is substantially perpendicular to the coupling piece 63. The second flange 62 defines a cutout 621 and two positioning holes 622. The coupling piece 63 defines two latching holes 631.

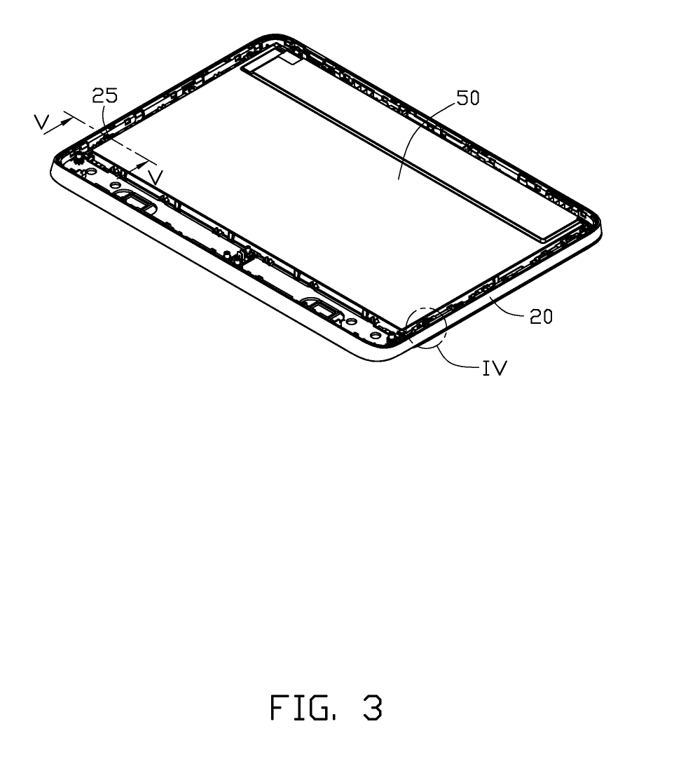

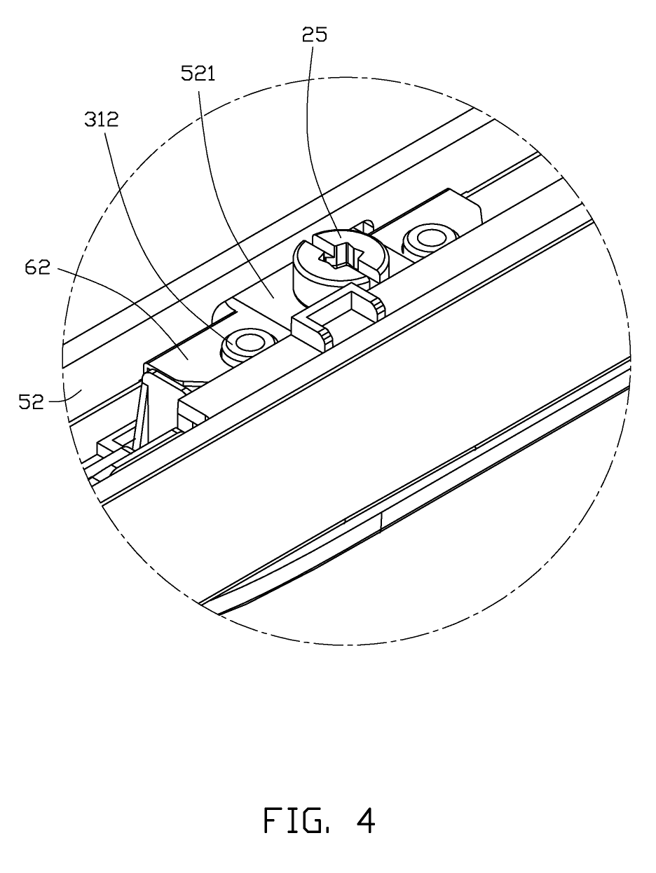

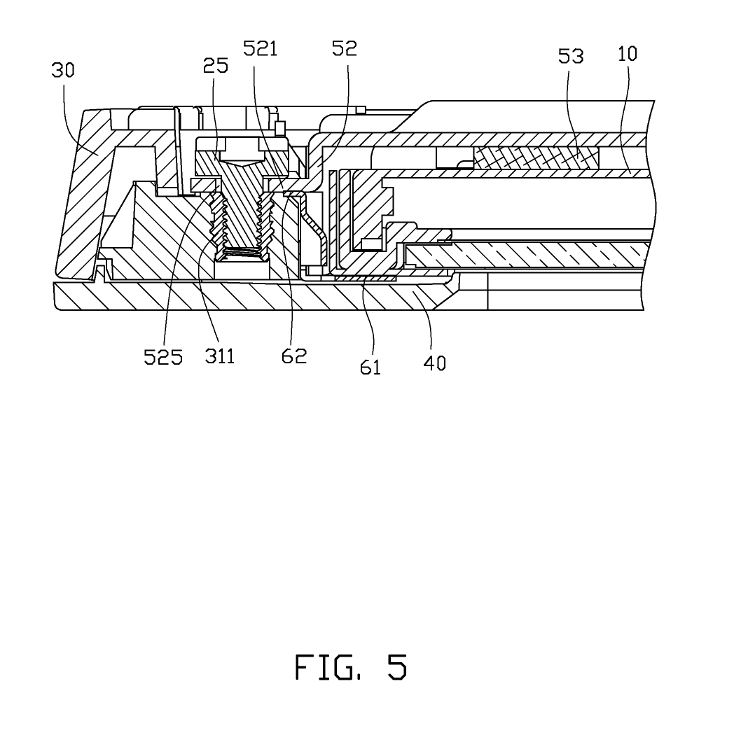

Referring to FIGS. 3-5, in assembly, the holding frame 40 is placed within the outer frame 30, the latching ribs 41 are elastically deformed to engage with the latching portions 32, so that the holding frame 40 is secured to the outer frame 30. The latching member 60 is moved to the installation portion 31 with the cutout 621 aligned with the mounting hole 311. The blocks 313 are engaged in the latching holes, and the positioning posts 312 are engaged in the positioning holes 622, so that the latching member 60 is secured to the outer frame 30.

The display panel 10 is moved in the mounting frame 20, edges of the display panel 10 abut the first flange 61. The resilient members 53 are placed on the display panel 10, the rear cover 50 is placed on the display panel 10, and the resilient members 53 are located between the display panel 10 and the rear cover 50, the mounting pieces 521 abut the second flange 62. The through hole 525 is aligned with the mounting hole 311. The fastener 25 is inserted into the mounting hole 311 through the through hole 525 to secured the rear cover 50 to the outer frame 30. The resilient members 53 are elastically deformed by the covering plate 51 and exert elastic force to engage the display panel 10 to the mounting frame 20.

The embodiments shown and described above are only examples. Many details are often found in the art such as the other features of an electronic device with display panel. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An electronic device comprising:
a mounting frame comprising a plurality of installation portions;
a plurality of latching members secured to the installation portions;
a rear cover;
a display panel located between the latching members and the rear cover; and
a plurality of fasteners engaged with the installation portions through the rear cover to secure the rear cover and the display panel to the mounting frame.

2. The electronic device of claim 1, wherein each installation portion defines a mounting hole, and each fastener is engaged in the mounting hole through the rear cover.

3. The electronic device of claim 2, wherein each installation portion comprises a positioning post, each latching member defines a positioning hole, and the positioning post is engaged in the positioning hole.

4. The electronic device of claim 2, wherein each installation portion further comprises a block, each latching member further defines a latching hole, and the block is engaged in the latching hole.

5. The electronic device of claim 2, wherein each latching member further defines a cutout aligned with the mounting hole, and each fastener extends through the cutout.

6. The electronic device of claim 1, wherein the mounting frame comprises an outer frame and a holding frame secured to the outer frame, the installation portions extend from the outer frame, and the holding frame abuts against the display panel.

7. The electronic device of claim 6, wherein the outer frame comprises a plurality of latching portions, the holding frame comprises a plurality of latching ribs, and the latching ribs are elastically deformable to engage with the latching portions.

8. The electronic device of claim 1, wherein the rear cover comprises a covering plate covering the display panel.

9. The electronic device of claim 8, wherein the rear cover further comprises a plurality of side plates substantially perpendicularly coupled to the covering plate, each side plate defines a through hole, and each fastener extends through the through hole.

10. The electronic device of claim 8, further comprising a plurality of resilient members, wherein the resilient members are elastically deformed to resist the display panel and located between the covering plate and the display panel.

11. An electronic device comprising:
a mounting frame comprising a plurality of installation portions;
a plurality of latching members secured to the installation portions;
a rear cover secured to the mounting frame via the installation portions;
a display panel located between the latching members and the rear cover; and
a plurality of resilient members being elastically deformed to resist the display panel and located between the rear cover and the display panel.

12. The electronic device of claim 11, further comprising a plurality of fasteners engaged with the installation portions through the rear cover to secure the rear cover and the display panel to the mounting frame.

13. The electronic device of claim 12, wherein each installation portion defines a mounting hole, and each fastener is engaged in the mounting hole through the rear cover.

14. The electronic device of claim 12, wherein each installation portion comprises a positioning post, each latching member defines a positioning hole, and the positioning post is engaged in the positioning hole.

15. The electronic device of claim 14, wherein each installation portion further comprises a block, each latching member further defines a latching hole, and the block is engaged in the latching hole.

16. The electronic device of claim 14, wherein each latching member further defines a cutout aligned with the mounting hole, and each fastener extends through the cutout.

17. The electronic device of claim 11, wherein the mounting frame comprises an outer frame and a holding frame secured to the outer frame, the installation portions extend from the outer frame, and the holding frame abuts against the display panel.

18. The electronic device of claim 17, wherein the outer frame comprises a plurality of latching portions, the holding frame comprises a plurality of latching ribs, and the latching ribs are elastically deformable to engage with the latching portions.

19. The electronic device of claim 12, wherein the rear cover comprises a covering plate covering the display panel.

20. The electronic device of claim 19, wherein the rear cover further comprises a plurality of side plates substantially perpendicularly coupled to the covering plate, each side plate defines a through hole, and each fastener extends through the through hole.
